(19) United States
(12) Patent Application Publication
(10) Pub. No.: US 2009/0123506 A1
(43) Pub. Date: May 14, 2009

(54) Method of Producing Protective Cable Sheaths, Tubes and Similar

(76) Inventors: Jordi Relats, Caldes de Montbui (Barcelona) (ES); Pere Relats, Caldes de Montbui (Barcelona) (ES); Artola Dolors, Caldes de Montbui (Barcelona) (ES); Anna Fruns, Caldes de Montbui (Barcelona) (ES)

Correspondence Address: THE NATH LAW GROUP, 112 South West Street, Alexandria, VA, 22314, US

(21) Appl. No.: 11/989,530

(22) PCT Filed: Jul. 27, 2006
(86) PCT No.: PCT/ES2006/000439

§ 371 Date: Jan. 28, 2008

(30) Foreign Application Priority Data
Jul. 29, 2005 (ES) P 200501940

(51) Int. Cl. A01N 25/34

(52) U.S. Cl. 424/411

(57) ABSTRACT

The manufacturing method includes the incorporation of a rodent repellent product, (1a & 1b) specifically (saccharyde of benzyldiethyl [(2,6-xililcarbamoilmethyl)] ammonium, capsaicine derivatives of izoate N-{2-[(2,6-dimethylphenyl)amino]-2-oxoethyl}-n,n-diethylbenzenmethanamine, (e)-8-methyl-N-vainilla-6-nonenamide, derivatives of oleoresine, capsaicinoids in an LDPE vehicular resin), in a solid form of pellets (1a), or in powder (1b) in any composition of any of the materials (2a & 2b) with which any of the constitutive elements (3) of the sheath (4) are formed, said repellent product thus being incorporated in the sheath (4).

### OBJECT OF THE INVENTION

The invention relates to a method of producing cable sheaths, tubes and similar.

### BACKGROUND TO THE INVENTION

At the present time, in some sectors, such as the automotive industry, it is common to sheath bundles of cables or tubes in order to keep them together and to provide them with some additional mechanical protection against chaffing, or against external agents that could damage them, such as heat sources.

In this sense, it is normal in the electrical installation of a vehicle the cables to be placed inside a flexible cover that prevents chaffing against the metal parts and/or cuts of the bodywork, preventing the risk of short circuits from the wear and tear of the insulating material that covers them and from vibrations, in addition to make the factory fitting easier.

In certain cases a protective sheath is placed around the tubes and cables that are exposed to bad weather, protecting them from solar radiation and water.

However, in some cases these cables are attacked by rodents and certain animals that bite the protective sheath, leaving the conductor core open and being able to cause a short circuit or even a small fire. In this case the sheaths only slow down the appearance of the problems, because they are also attacked in the same way by the rodents.

Some of these sheaths are described in the utility models U200103125, U200103124 and 200103122 of the same applicant as this present invention.

In the utility model U200103125 a sheath or tube is described for the protection of cables that is made up of a plurality of glass fibre woven threads and a polyurethane covering that makes them temperature resistant.

In utility model U200103124 a sheath or tube is described for the protection of cables that is made up of a plurality of threads making the tube with a covering of a silicone emulsion that is applied in a liquid or paste manner for subsequent curing.

In utility model U200103122 a sheath or tube is described for the protection of cables that is made up of a plurality of woven polyester threads with a reinforcing cover. Said polyester threads or filaments also even being made with no treatment.

Rodent repelling products are applied to these sheaths or tubes by means of spraying or impregnating the external surface of the sheath or cable. These repellents give off smells that are unpleasant for the rodents or give off unpleasant tastes that reduce the risk of the animals chewing them, at least in a repetitive manner. However, this means of application, by spraying, the repellent product offers a limited persistence, as the environmental agents such as solar radiation, heat and rainwater given off in a certain short period of time leave the material without any protection.

For example, American patent U.S. Pat. No. 5,674,496 to Etscorn and others describes a substance made from spicy or irritant plant extracts for use as a natural repellent against rodents on being mixed in with raw materials, such as paints and resins in order to provide protection against the bites by said animals.

European patent EP227987 to Tanabe Seiyaku Co. Ltd. is also known, including the use of cyclohexamide as a rodent repellent, which can be mixed with the raw materials for protection. In said patent, the product cyclohexamide is stabilised and its useful working life is extended by means of the use of a microcapsule that avoids its dilution in water and damp environments. However, said microcapsule limits the number of polymers with which it can be combined.

A final example is that described in Japanese patent application JP2002271934 to Furukawa Electric Co. Ltd. in which a flexible resin protective covering that includes a rodent repellent agent is used to provide protection to a fibre optic cable on the inside of a sewer. This covering is hollow in order to house several cables if it is necessary.

### DESCRIPTION OF THE INVENTION

The method for the manufacture of producing cable sheaths, tubes and similar of this invention has a series of technical peculiarities that provide on-going persistence for the product throughout the useful working life of the sheath, greater resistance to the attack of rodents and greater ease of application.

The manufacturing method includes the incorporation of a rodent repellent product, such as RODREPEL® (saccharyde of benzyldiethyl [(2,6-xililcarbamoilmethyl)] ammonium, capsaicine derivatives of izoate N-{2-[(2,6-dimethylphenyl)amino]-2-oxoethyl}-n,n-diethylbenzenmethanamine, (e)-8-methyl-N-vainilla-6-nonenamide, derivatives of oleoresine, capsaicinoids in an LDPE vehicular resin), in a solid form in any composition of any of the materials with which any of the constitutive elements of the sheath are formed, said repellent product being incorporated in the composition of said material. This repellent product is stable throughout the useful working life of the sheath and is not toxic or harmful to the animals or insects.

The repellent product on being incorporated into the composition of one of the materials destined to make up the sheath; the repellent is not affected by wear and tear, solar radiation, rain or other external agents, thus guaranteeing its permanence throughout the useful working life of the protective sheath.

The repellent product is added to a polyester or other thermo-plastic pellet form prior to the formation of the thread or filament that is going to be used for the formation of the braided sheath. It has also been foreseen that the repellent product is added in powder form when it is going to be added to liquid or paste polyurethane, prior to its polymerisation.

Once the sheath is formed, the element shaped with the material that includes the repellent in its composition, exercises a repellent effect inasmuch as when the rodent approaches or bites the sheath and it notes an unpleasant taste or smell.

### DESCRIPTION OF THE DRAWINGS

In order to complement the description that is being carried out and for the purpose of making the characteristics of the invention easier to understand, this present description is accompanied by a set of drawings that are by way of illustration but without being in any way limiting, in which the following has been represented:

FIG. 1 shows a scheme for the manufacturing method of a sheath that incorporates polyester threads and in which the repellent, in the form of pellets, is added to the polyester siftings with which said threads are formed.

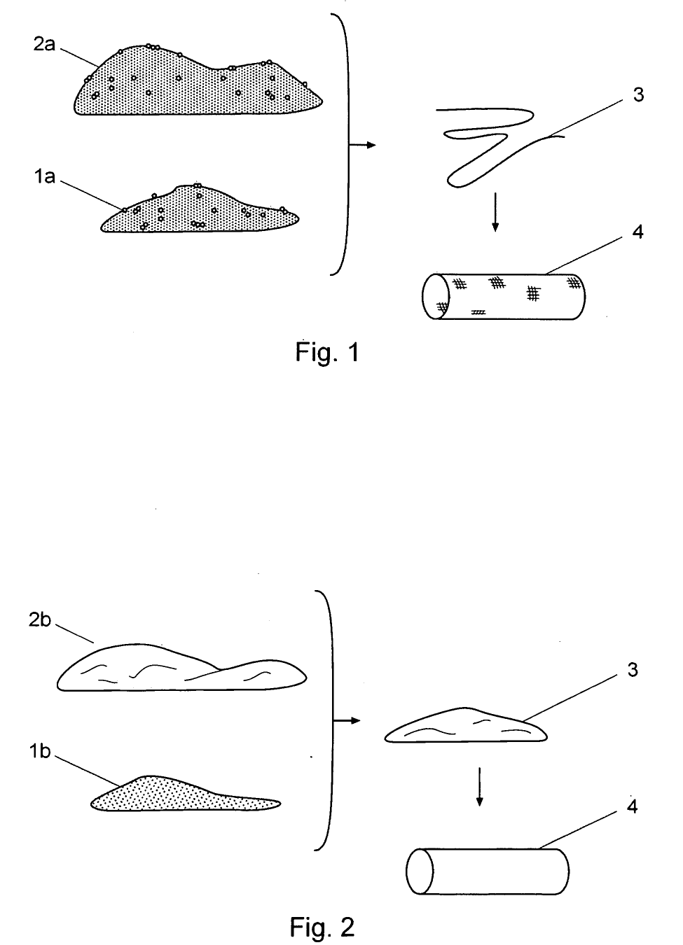

FIG. 2 shows a manufacturing method scheme of a sheath that incorporates polyurethane, carrying out the addition of the repellent to the still liquid or paste polyurethane, in the form of a powder.

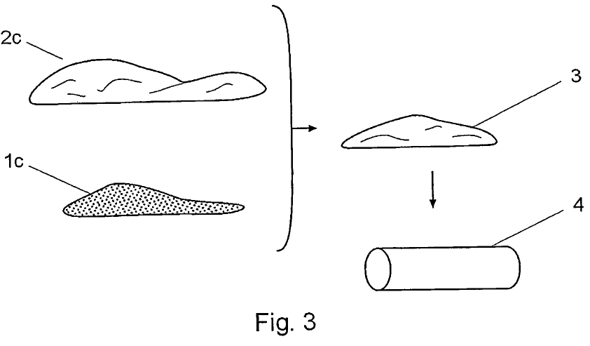

### PREFERRED EMBODIMENT OF THE INVENTION

As can be seen in the figures the method for the manufacture includes the incorporation of a repellent product, either in the form of pellets (1a) or in powder (1b) to the composition of any of the materials (2a, 2b) with which any of the constitutive elements (3) of the sheath (4) are being formed, said incorporation being carried out prior to the making up of said element and without altering its structure.

In the case in which the sheath (4) includes polyester threads (3), the rodent repellent product is added in the form of pellets (1a), to the polyester siftings or material (2a) prior to the forming of the polyester thread (3), the repellent product being incorporated into the polyester threads (3).

In the case in which the sheath (4) includes glass and polyurethane fibre (2b) the repellent product is added in powder form (1b) to the liquid or paste polyurethane prior to its application and polymerisation or curing.

The product suited to said purposes is that which is marketed by the company C-tech Corporation under the name of RODREPEL® and which has the following formulation: Saccharyde of benzyldiethyl [(2,6-xililcarbamoilmethyl)] ammonium, capsaicine derivatives of izoate N-{2-[(2,6-dimethylphenyl)amino]-2-oxoethyl}-n,n-diethylbenzenmethanamine, (e)-8-methyl-N-vainilla-6-nonenamide, derivatives of oleoresine, capsaicinoids in an LDPE vehicular resin.

Once having sufficiently described the nature of the invention likewise an example of a preferred embodiment it is placed on record to whom it may concern that the materials, shape, size and arrangement of the elements described can be appropriately modified and do not stray away from the essential nature of the invention that are claimed below.

1. A method for the manufacture of protective sheaths for cables, tubes and similar items, that includes the incorporation of a rodent repellent product in the composition of any of the materials (2a, 2b) with which any of the constitutive elements (3) of the sheath (4) are being formed, said repellent product being incorporated internally into the sheath (4), characterised by the addition of the repellent product: saccharyde of benzyldiethyl [(2,6-xililcarbamoilmethyl)] ammonium, capsaicine derivatives of izoate N-{2-[(2,6-dimethylphenyl)amino]-2-oxoethyl}-n,n-diethylbenzenmethanamine, (e)-8-methyl-N-vainilla-6-nonenamide, derivatives of oleoresine, capsaicinoids in an LDPE vehicular resin, in a solid form either in the form of pellets (1a) to the polyester pellets or other thermoplastic material (2a) prior to the formation or the thread or filament that is to be used as an element (3) for the formation of the sheath (4); or as powder (1b) to the polyurethane liquid or paste material (2b) prior to application and curing, when the sheath (4) is made up of fibre glass and polyurethane elements (3).

2-4. (canceled)
